(19) United States
(12) Patent Application Publication
(10) Pub. No.: US 2015/0191148 A1
(43) Pub. Date: Jul. 9, 2015

(54) Sleeper Berth Restraint

(71) Applicant: Liliana Chiciu, Newnan, GA (US)

(72) Inventor: Liliana Chiciu, Newnan, GA (US)

(21) Appl. No.: 14/591,575

(22) Filed: Jan. 7, 2015

Related U.S. Application Data
(60) Provisional application No. 61/924,290, filed on Jan. 7, 2014.

(51) Int. Cl. B60R 22/14

(52) U.S. Cl. CPC B60R 22/14

(57) ABSTRACT

A sleeper berth restraint for commercial vehicles. The sleeper berth restraint includes a webbed harness having a first section and a second section. Each section includes a plurality of vertical straps secured to a plurality of horizontal straps so as to form a grid configuration. The first and second sections are removably secured to one another by means of mating fasteners thereon. The upper and lower ends of the vertical straps include fasteners thereon for securement to the upper and lower rails at the opening or entry of a sleeper berth. Further, the sides of the sections include fasteners for securement to the interior walls of the vehicle. The webbed harness is enclosed between a pair of curtains secured thereon. Thus, the sleeper berth restraint helps to prevent a resting driver from being thrown from the sleeper berth in the event of an accident.

### CROSS REFERENCE TO RELATED APPLICATION

This application claims the benefit of U.S. Provisional Application No. 61/924,290 filed on Jan. 7, 2014. The above identified patent application is herein incorporated by reference in its entirety to provide continuity of disclosure.

### BACKGROUND OF THE INVENTION

1. Field of the Invention

The present invention relates to sleeper berth restraints. More specifically, the present invention provides a sleeper berth restraint comprising a webbed harness having a first section and a second section, wherein each section is composed of a plurality of horizontal and vertical straps arranged in a grid configuration, wherein the harness is removably securable to the opening or entrance of a sleeper cab so as to prevent the resting driver from being thrown from the sleeper berth in the event of an accident while also providing privacy to the resting driver.

Many commercial vehicles, such as tractor trailers, include a sleeper berth, also referred to simply as a berth, for providing a space for the driver to rest while off-duty. The berth includes a bed arranged in the rear portion of the cab of the vehicle. Often, two drivers will ride in the same tractor trailer so that one can drive while the other rests in the berth. However, lying in the berth without any harness or securement means can be dangerous, and the resting driver can be injured if an accident occurs while the driver is sleeping.

Accordingly, to increase the safety of the resting driver while in the berth, conventional berths often include a harness or strap system for securing the driver in the sleeper berth. This helps to keep the driver safe in the event of an accident, since the driver would otherwise be unsecured in the berth. However, many truck drivers may find it uncomfortable to sleep while harnessed or strapped into the berth as the straps may be tight and can restrict the driver's movement. Thus, a restraint system for berths is provided that maintains the safety of the resting driver while improving comfort.

2. Description of the Prior Art

Devices have been disclosed in the prior art that relate to sleeper berth restraints. These include devices that have been patented and published in patent application publications. These devices generally relate to harnesses for improving safety to a user resting in a sleeper berth of a vehicle. The following is a list of devices deemed most relevant to the present disclosure, which are herein described for the purposes of highlighting and differentiating the unique aspects of the present invention, and further highlighting the drawbacks existing in the prior art.

One such device, U.S. Pat. No. 5,876,059 to Kleinberg discloses a vehicle sleeper bunk restraint system. The device includes airbags installed above and in front of the occupant of the bunk area to provide restraint and collision protection. The system includes a shelf above the bunk in which the airbags are positioned. The shelf further includes a fabric curtain connecting the front of the shelf to the lower bunk to restrict forward movement of the occupant during rapid deceleration. Thus, while Kleinberg discloses a vehicle sleeper bunk restraint system, Kleinberg fails to disclose the use of airbags rather than a webbed harness system to protect the occupant of the sleeper berth in the event of an accident.

Another device, U.S. Pat. No. 7,097,204 to Jessup et al. discloses a sleeper bunk restraint system. The system includes a sleeper bunk configured for use by a vehicle, wherein the system includes a top surface on which a user can rest. The bunk further includes a stationary portion and a movable portion, wherein the movable portion can move towards the stationary portion to form a barrier. A restraining member can be included that helps to restrain movement of the movable portion, so as to maintain the barrier in position. Thus, Jessup et al. discloses a sleeper bunk of a particular construction, and does not disclose a harness system for restraining a user within a conventional sleeper berth.

U.S. Pat. No. 5,375,879 to Williams et al. discloses a vehicle sleeper restraint. The sleeper restraint comprises a net having a web framework, wherein the web framework further includes retracting devices. The net and webbing can be extended from a stored configuration to an active configuration wherein the webbing is disposed over a bed having buckles to engage tongues mounted to the framework. While Williams et al. discloses a sleeper restraint system, the system does not disclose a webbed harness having fasteners securable to the upper and lower rails of a sleeper berth adjacent to the curtains thereon.

U.S. Pat. No. 7,552,488 to Martin et al. discloses a restraint device for a bed in a motor vehicle. The device is attachable to the bed via a pivot bolt, wherein the pivot bolt also connects the side slat of the bed frame and a pivot bracket. Thus, Martin et al. fails to disclose a webbed harness securable in a vertical orientation adjacent to a sleeper berth to prevent the user from being thrown from the sleeper berth in the event of an accident.

U.S. Pat. No. 5,529,341 to Hartigan discloses a restraining net for passenger vehicles. The device comprises a rectangular mesh affixed within a support frame. Upper belts are removably connected to the shoulder belts of the passenger vehicle, and a pair of lower belts is removably connected to the frame of the vehicle seat. Thus, Hartigan fails to disclose a restraint for a sleeper berth and instead discloses a restraint for passenger vehicles.

Finally, U.S. Pat. No. 3,695,698 to Trump discloses a restraint device for a vehicle cab sleeper bunk. The device comprises a web-like harness composed of flexible straps attached to the cab structure to provide a vertical support extending across the open front of the bunk. The device further includes a horizontal leg extending over the bunk to the rear of the cab structure. The harness includes quick release buckles to allow the occupant to enter and exit the bunk. Thus, Trump discloses a restraint device, but fails to disclose a webbed harness having a pair of sections removably securable to one another, and wherein the webbed harness is disposed in a vertical orientation and is securable to the upper and lower portions of the cab structure by means of fasteners thereon.

These prior art devices have several known drawbacks. The devices in the prior art generally relate to restraint systems for sleeper bunks in a vehicle. Such devices fail to provide a webbed harness having a plurality of straps removably securable to the upper and lower portions of the sleeper berth on the open front thereof, wherein the harness is attached to a curtain for dividing the sleeper berth from the remainder of the vehicle cabin.

In light of the devices disclosed in the prior art, it is submitted that the present invention substantially diverges in design elements from the prior art and consequently it is clear that there is a need in the art for an improvement to existing sleeper berth restraint devices. In this regard the instant invention substantially fulfills these needs.

### SUMMARY OF THE INVENTION

In view of the foregoing disadvantages inherent in the known types of sleeper berth restraints now present in the prior art, the present invention provides a new sleeper berth restraint wherein the same can be utilized for providing convenience for the user when resting or lying in a sleeper berth of a vehicle, such as a tractor trailer.

It is therefore an object of the present invention to provide a new and improved sleeper berth restraint device that has all of the advantages of the prior art and none of the disadvantages.

It is another object of the present invention to provide a sleeper berth restraint comprising a webbed harness having a first and second section removably securable to one another, wherein each section is composed of a plurality of flexible straps arranged in a grid configuration.

Another object of the present invention is to provide a sleeper berth restraint having fasteners on the upper and lower ends thereof for securing the device in a vertical orientation over the open front of the sleeper berth.

Yet another object of the present invention is to provide a sleeper berth restraint having at least one curtain attached thereto.

Another object of the present invention is to provide a sleeper berth restraint that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a planar view of the sleeper berth restraint of the present invention.

FIG. 2 shows a view of the sleeper berth restraint of the present invention as secured to a sleeper berth.

FIG. 3 shows a disassembled view of the sleeper berth restraint of the present invention.

FIG. 4 shows a view of the sleeper berth restraint of the present invention having curtains thereon.

### DETAILED DESCRIPTION OF THE INVENTION

Reference is made herein to the attached drawings. Like reference numerals are used throughout the drawings to depict like or similar elements of the sleeper berth restraint. For the purposes of presenting a brief and clear description of the present invention, the preferred embodiment will be discussed as used for restraining a driver of a vehicle while resting in the vehicle's sleeper berth. The figures are intended for representative purposes only and should not be considered to be limiting in any respect.

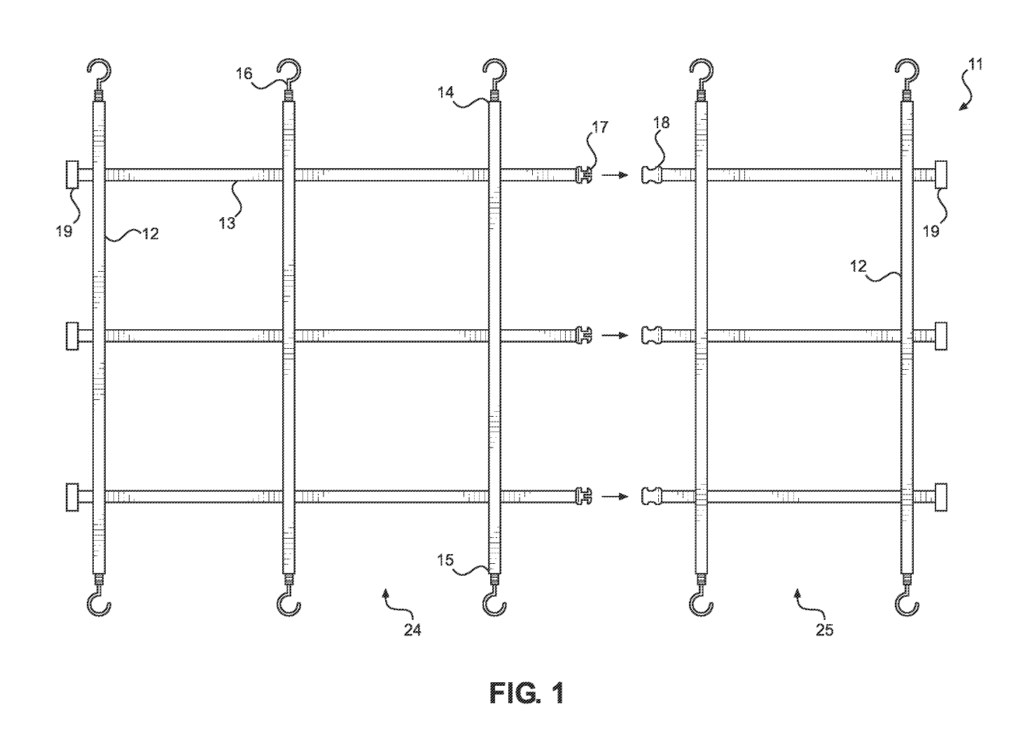

Referring now to FIG. 1, there is shown a planar view of the sleeper berth restraint of the present invention. The sleeper berth restraint 11 comprises a webbed harness having a first section 24 and a second section 25. Each section 24, 25 is composed of a plurality of vertical straps 12 and a plurality of horizontal straps 13 arranged in a grid configuration. In a preferred embodiment, the vertical straps 12 are substantially perpendicular to the horizontal straps 13. Further, the vertical straps 12 are spaced at a fixed interval and the horizontal straps 13 are spaced at a fixed interval. The vertical straps 12 and horizontal straps 13 are composed of a durable, flexible fabric material that allows the straps 12, 13 to bend or stretch in order to absorb the impact in the event of an accident.

The vertical straps 12 further include fasteners 16 on an upper end 15 and lower end 16 thereof. The fasteners 16 preferably include hooks or carabiners for removably fastening the restraint 11 to upper and lower portions of the open front of the sleeper berth. However, in alternate embodiments, other types of fasteners may be used.

The first section 24 and the second section 25 are removably securable to one another by means of mating fasteners 17, 18 thereon. The horizontal straps 13 of the first section 24 each include a male fastener 17 on an end thereof that is adapted to be inserted into the female fastener 18 on an end of each of the horizontal straps 13 of the second section 25. Thus, the mating fasteners 17, 18 allow the first and second sections 24, 25 to be removably secured to one another so as to form a wall structure that encloses the open front of the sleeper berth. When the user desires to enter or exit the sleeper berth, the user can disconnect the mating fasteners 17, 18 to create a space between the first and second sections 24, 25 so as to allow the user to easily move into and out of the sleeper berth.

Further, the outer ends of each of the horizontal straps 13 include wall fasteners 19 thereon that are adapted to secure the harness 11 to the walls of the sleeper berth. The wall fasteners 19 may include a fastening member having an adhesive surface, or may include brackets and either bolts or screws for securement to the walls of the sleeper berth. However, any suitable fastening means may be used for securing the horizontal straps 13 to the walls of the sleeper berth. Thus, the wall fasteners 19 help to secure the webbed harness in position on the sleeper berth, and help to stabilize the webbed harness 11.

Each of the first and second sections 24, 25 of the webbed harness is disposed between a pair of curtains, such that each section 24, 25 is enclosed by the curtains. The curtains are secured to the first and second sections 24, 25 by any suitable fastening means, such as stitching or adhesives, among others. The curtains provide privacy to the person sleeping in the sleeper berth, help to dampen noise from the cabin of the vehicle, and block light from the sleeper berth. The curtains can be composed of any suitable fabric material, and may also provide an insulating effect.

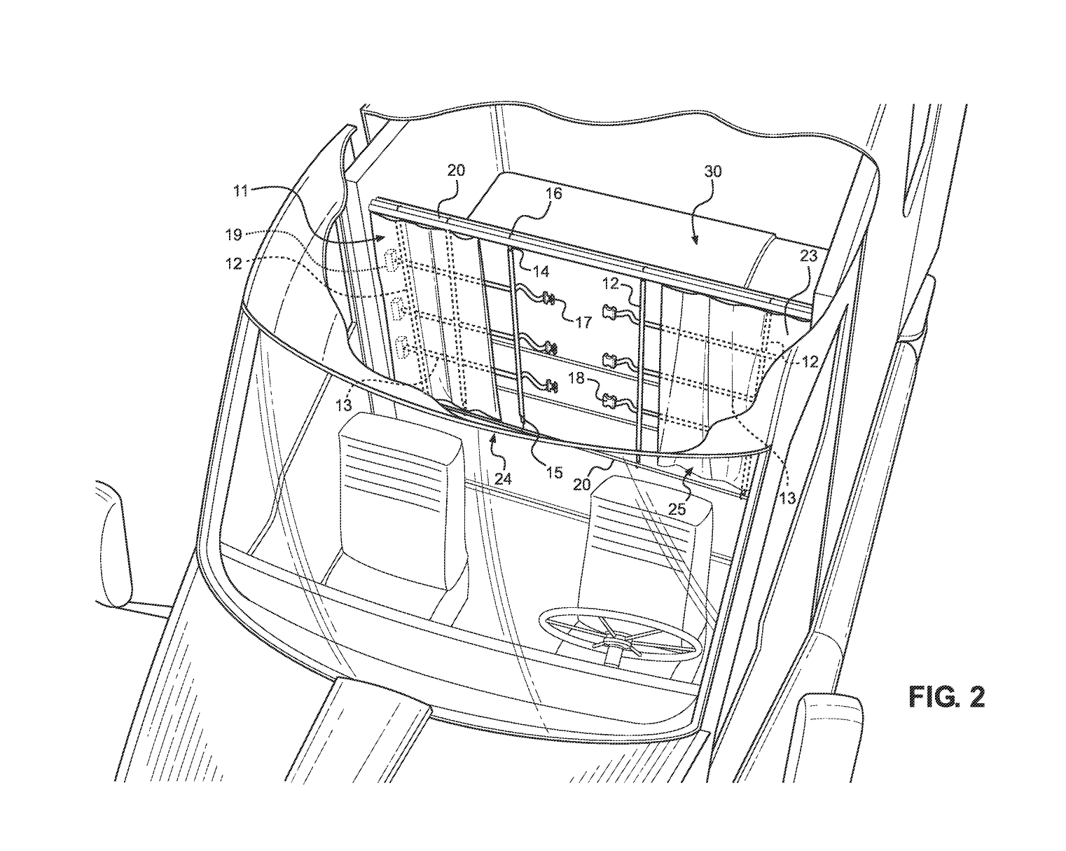

Referring now to FIG. 2, there is shown a view of the sleeper berth restraint of the present invention as secured to a sleeper berth. The webbed harness is secured to the sleeper berth 30 in a vertical orientation on the open front portion thereof, wherein a first section 24 covers one half of the sleeper berth 30 and a second section 25 covers a second half thereof. Each section 24, 25 is secured to the upper and lower rails 20 of the sleeper berth 30 by means of the fasteners 16 thereon. The fasteners 16 can slide along the rails 20 so that the first and second sections 24, 25 can be spaced from one another, forming a gap therebetween. Further, each section 24, 25 is secured to the walls of the sleeper berth 30 by means of the wall fasteners 19 thereon.

The webbed harness serves as a barrier over the open front of the sleeper berth 30, preventing the user from being thrown from the sleeper berth 30 in the event of an accident. The webbed harness substantially covers the open front of the sleeper berth 30. The webbed harness extends from the lower portion of the sleeper berth 30 to the upper portion, and also extends between opposing sides thereof. The fasteners 16 on the upper end and lower end of the vertical straps 12 can be secured to a portion of the sleeper berth 30. In the illustrated embodiment, the fasteners 16 are secured to horizontal rails 20 on the upper end and lower end of the sleeper berth 30. The fasteners 16 can be removably secured so as to allow the restraint 11 to be removed or installed as desired.

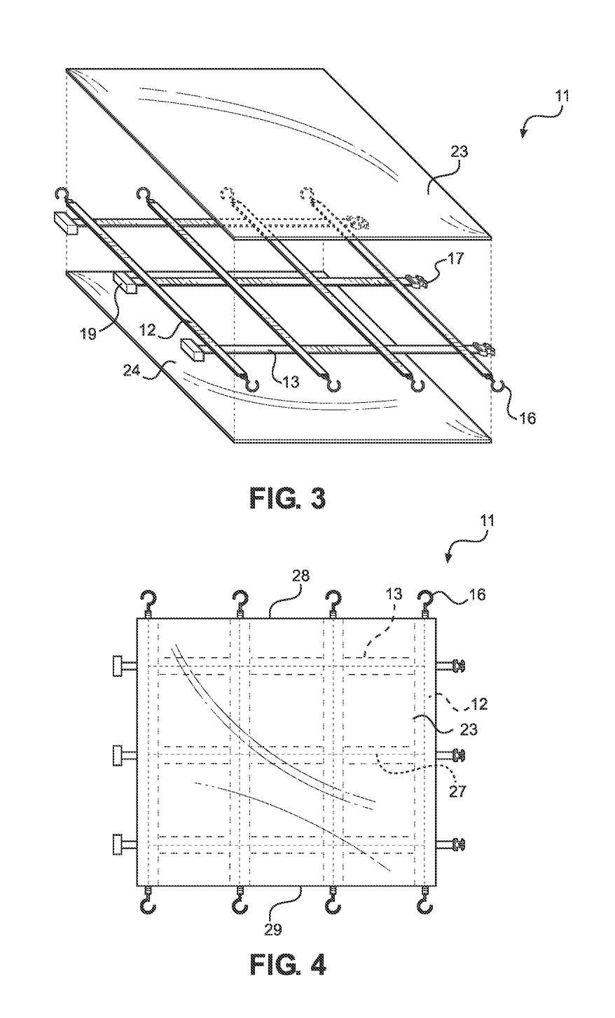

Referring now to FIGS. 3 and 4, there are shown a disassembled view of the sleeper berth restraint of the present invention, and a view of the sleeper berth restraint of the present invention having curtains thereon. A first curtain 23 is provided that is secured to an exterior surface of each section of the webbed harness. The first curtain 23 may include a rectangular sheet that substantially covers the vertical and horizontal straps of each section. Thus, the fasteners on the sides and on the upper and lower ends are preferably not covered by the curtains 23, 24. Further, a second curtain 24 is secured to the opposing surface or interior surface of the webbed harness. In this way, the webbed harness is enclosed between the first and second curtains 23, 24.

The fasteners 16 on the upper and lower ends of the vertical straps extend outward from the curtains 23, 24 so that they can be easily accessed. Further, the wall fasteners also extend outward from the curtains so that they can be easily attached to the walls of the sleeper berth. Preferably, the curtains 23, 24 are secured to the first and second sections of the webbed harness by means of stitching 27 or other suitable fastening means. Thus, the curtains may be stitched to the vertical and horizontal straps along the lengths thereof. Further the curtains may be stitched about the perimeters thereof.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A sleeper berth restraint, comprising:
a webbed harness comprising a first section and a second section, wherein each of said first and second sections comprises a plurality of vertical straps and a plurality of horizontal straps arranged in a grid;
wherein each of said plurality of vertical straps includes an upper end and a lower end, said upper end and said lower end each having a fastener thereon;
wherein said plurality of horizontal straps each include a wall fastener on an outer end thereof;
wherein each of said plurality of horizontal straps on said first section comprise a male fastener adapted to removably engage with a female fastener disposed on each of said plurality of horizontal straps of said second section, such that said first and second sections can be removably secured to one another.

2) The sleeper berth restraint of claim 1, wherein said fastener on said plurality of vertical straps is a hook.

3) The sleeper berth restraint of claim 1, wherein said fastener on said plurality of vertical straps is a carabiner.

4) The sleeper berth restraint of claim 1, further comprising a first curtain secured to an exterior surface of said first section of said webbed harness.

5) The sleeper berth restraint of claim 4, further comprising a second curtain secured to an interior surface of said first section of said webbed harness.

6) The sleeper berth restraint of claim 4, wherein said first curtain is secured to an exterior surface of said first section of said webbed harness by means of stitching.

7) The sleeper berth restraint of claim 1, wherein said webbed harness is adapted to be secured in a vertical orientation to an open front portion of a sleeper berth.

8) The sleeper berth restraint of claim 1, wherein said plurality of vertical straps and said plurality of horizontal straps are composed of a flexible fabric material.
